(19) United States
(12) Patent Application Publication
(10) Pub. No.: US 2025/0067236 A1
(43) Pub. Date: Feb. 27, 2025

(54) Rigid Skeleton In-Tank Filter Housing for Improving Effectiveness of Sodium Polyacrylate Mixtures for Fuel Treatment

(71) Applicants: Stephen Schultz, Chuluota, FL (US); Christian Rabøl, Havdrup (DK)

(72) Inventors: Stephen Schultz, Chuluota, FL (US); Christian Rabøl, Havdrup (DK)

(21) Appl. No.: 18/811,496

(22) Filed: Aug. 21, 2024

Related U.S. Application Data
(60) Provisional application No. 63/534,525, filed on Aug. 24, 2023.

(51) Int. Cl. F02M 37/50; F02M 37/34; F02M 37/42

(52) U.S. Cl. CPC F02M 37/50; F02M 37/34; F02M 37/42

(57) ABSTRACT

Rigid skeleton in-tank filter housing for improving effectiveness of Sodium Polyacrylate mixtures for fuel and oil treatment is disclosed. The rigid skeleton in-tank filter housing creates the structure providing the open interior space that is necessary for Sodium Polyacrylate mixtures to freely absorb and capture water and to expand without obstruction or constriction. By creating this open and free space inside the in-tank housing with the rigid structure combined with an exterior or integrated skin of mesh or other permeable fabric, the rigid housing creates a significantly more effective solution that allows Sodium Polyacrylate mixtures to achieve better absorption, thus better results.

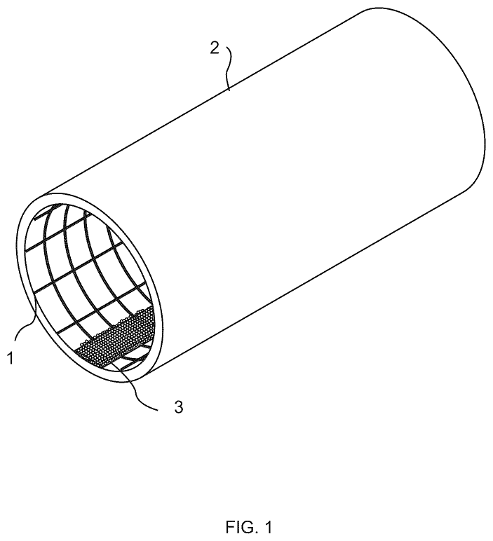

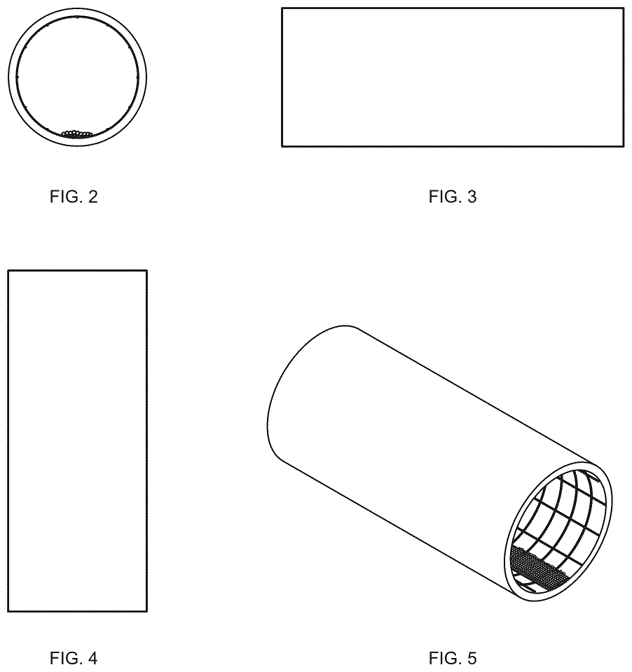

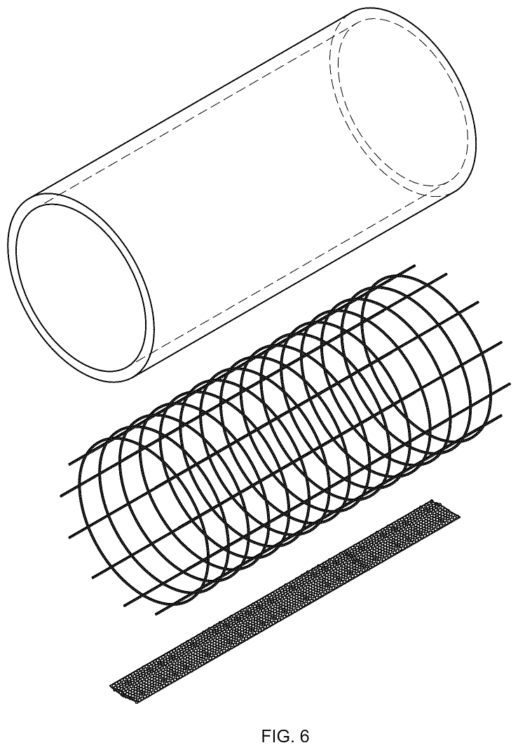

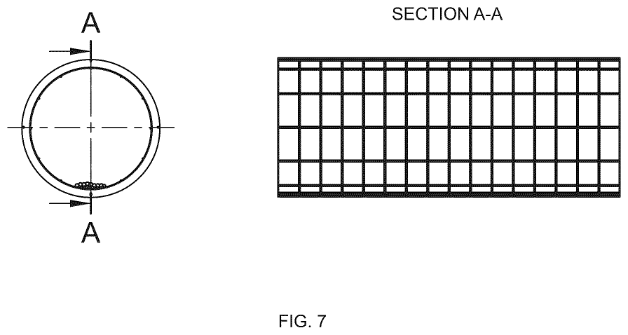

### BACKGROUND

Problem Solved: Existing in-tank Sodium Polyacrylate products for fuel and oil remediation including pouches, bags and devices without a rigid structural space-creating frame; and are restrictive in allowing Sodium Polyacrylate mixtures to expand and absorb water effectively, thus limiting their ability to absorb water and making them less efficient in producing intended results.

Existing devices are designed without the appropriate structure to create the open space necessary to allow Sodium Polyacrylate mixtures to grow and expand which limits their effectiveness at absorbing water, which is the purpose of Sodium Polyacrylate mixtures in fuel and oil applications. Because Sodium Polyacrylate does not have the strength when absorbing water to expand within, to push or to displace fabric or other obstructions; these existing products have proven to be less effective.

Exemplary embodiments of the present disclosure include a rigid skeleton in-tank filter housing that creates the structure providing the open interior space that is necessary for Sodium Polyacrylate mixtures to freely absorb and capture water and to expand without obstruction or constriction. By creating this open and free space inside the in-tank housing with the rigid structure combined with an exterior or integrated skin of mesh or other permeable fabric, exemplary embodiments of the rigid housing create a significantly more effective solution that allows Sodium Polyacrylate mixtures to achieve better absorption, thus better results.

### DETAILED DESCRIPTION

As stated above, existing in-tank Sodium Polyacrylate products for liquid fuel and oil remediation including pouches, bags and devices without a rigid structural space-creating frame; and are restrictive in allowing Sodium Polyacrylate mixtures to expand and absorb water effectively, thus limiting their ability to absorb water and making them less efficient in producing intended results. Exemplary embodiments of the present disclosure solve this problem.

In exemplary embodiments, the rigid skeleton in-tank filter housing introduces a rigid structural support inside of or integrated into a liquid permeable skin, made of fabric, mesh or other material; that permits liquid to pass through the membrane and have contact with the Sodium Polyacrylate mixture that is contained within the housing to extract and absorb water from fuel or oil. Because of the space provided inside of the in-tank housing by the rigid structure, the Sodium Polyacrylate mixture can expand unimpeded within the housing so that it can absorb water without obstruction or constriction. This space allows the Sodium Polyacrylate mixture to absorb water to the full volume of the open space that the rigid structure creates while keeping the expanded Sodium Polyacrylate mixture within the housing and segregated from the tank environment.

Exemplary embodiments differ from what currently exists. The rigid in-tank housing creates the necessary space to allow Sodium Polyacrylate mixtures to expand freely within the housing to capture and absorb water more effectively, thus significantly improving its intended results. Existing in-tank Sodium Polyacrylate products have little or no supporting structure to create free and open space or are designed like an envelope which causes the permeable membrane to press down on or constrict absorption growth within the housing or have other restrictive elements in their design that prevent Sodium Polyacrylate mixtures from expanding freely and growing to absorb more water; thus limiting the intended effectiveness for water absorption inside these unsupported membranes.

Embodiments of the present disclosure are an improvement on what currently exists. The rigid in-tank housing creates the necessary space to allow Sodium Polyacrylate mixtures to expand freely within the housing to capture and absorb water more effectively, thus significantly improving its intended results. Other in-tank Sodium Polyacrylate products have little or no supporting structure to create free and open space or are designed like an envelope which causes the permeable membrane to press down on or constrict absorption growth within the housing or have other restrictive elements in their design that prevent Sodium Polyacrylate mixtures from expanding freely and growing to absorb more water; thus limiting the intended effectiveness for water absorption inside these unsupported membranes.

Existing devices use soft pouches or bags that fold over, close-off or lay on top of the Sodium Polyacrylate mixture which prevents the Sodium Polyacrylate mixture from absorbing water, which is required for its effectiveness with in-tank applications. These products lack the appropriate rigid structure to create the open space needed for Sodium Polyacrylate mixtures to grow and capture water to achieve better results.

In exemplary embodiments, the rigid skeleton in-tank filter housing creates the structure providing the open interior space that is necessary for Sodium Polyacrylate mixtures to freely absorb and capture water and to expand without obstruction or constriction. By creating this open and free space inside the in-tank housing with the rigid structure combined with an exterior or integrated skin of mesh or other permeable fabric, the rigid housing creates a significantly more effective solution that allows Sodium Polyacrylate mixtures to achieve better absorption, thus better results.

### Exemplary Embodiments Include:

1. Rigid integrated or inner skeleton
2. Permeable fabric or mesh membrane
3. Sodium Polyacrylate mixture

### Relationship Between the Components:

In exemplary embodiments, Item 1 creates internal free and open space within the housing while Item 2 allows liquid to pass into and through the housing while containing Item 3 within the housing. Item 3 interacts with the fuel or oil to extract and absorb water from the fuel or oil. Item 3 expands into the open space created by Item 1 as it absorbs water within the housing while being contained within the housing by Item 2. Without the space provided by Item 1, Item 3 cannot expand properly and thus will not effectively absorb water, which its intended purpose.

### How the Technology Works:

In exemplary embodiments, the rigid inner or integrated skeleton of the housing creates internal space to allow a Sodium Polyacrylate mixture to expand unimpeded as it absorbs water within the housing and allows for maximum expansion and water absorption. The permeable mesh or fabric membrane allows surrounding liquid such as fuel, oil or water from inside the tank to pass into and through the housing to interact with the Sodium Polyacrylate mixture while also keeping the Sodium Polyacrylate mixture contained within the housing.

### How to Make:

In exemplary embodiments, a perforated rigid structure is placed inside or integrated within a permeable fabric or mesh membrane or sleeve to create a tube, box or other shaped vessel or housing. The Sodium Polyacrylate mixture is placed inside the housing and the housing is sealed to keep the Sodium Polyacrylate mixture contained within the rigid permeable housing. The components are the rigid structural element, the permeable membrane and the Sodium Polyacrylate mixture that is contained within the housing.

Other elements that could be added are weights or magnets to keep the housing in place inside the tank. A cord such as a string or rope can be tied to the housing to allow for easier installation and retrieval of the housing into and out of an opening in the tank. A removable top in the housing could be used to make the housing easier for reuse.

In exemplary embodiments, this housing can also be made through a mold that integrates the rigid frame with the permeable fabric or mesh membrane. The housing can be made in different sizes or shapes to allow for different applications. The shape of the rigid structure can conform to specific tank bottoms to allow for maximum contact with the tank bottom. The size of the housing can be changed to fit within different tank opening sizes.

### How to Use:

In exemplary embodiments, the housing is installed inside of a fuel or oil tank at the bottom of the tank, suspended within the tank or in another location within the tank that is determined to be most effective for the specific application. The housing is designed to either remain in the tank long term, changed periodically or installed in a tank temporarily to remove unwanted bound water or free water and removed and replaced when needed or desired. Additionally: exemplary embodiments can be used as an insert for a pass-through filter to remove water from fuels or oils.

1. A system for in-tank fuel filtration, the system comprising:
an in-tank filter housing positioned inside a fuel tank, the in-tank filter housing comprising:
a rigid skeleton; and
a membrane, the membrane being permeable by liquid fuels and liquid water; and
the sodium polyacrylate mixture enclosed within the in-tank filter expanding into a space within the fuel tank and within the in-tank filter housing, the sodium polyacrylate mixture absorbing the liquid water.

2. The system of claim 1, the membrane comprising one or more of: fabric or mesh.

3. The system of claim 1, further comprising a cord connected to the in-tank filter housing and retrievable from an opening in the fuel tank.

4. The system of claim 1, the rigid housing being in the shape of a tube, box or other three-dimensional shape.

5. The system of claim 1, being used for petroleum diesels, biodiesels, gasolines, jet fuels and other liquid fuels and oils.

6. A method for in-tank fuel filtration, the method comprising:
inserting a sodium polyacrylate mixture into an in-tank filter housing, the in-tank filter housing comprising:
a rigid skeleton; and
a membrane, the membrane being permeable by liquid fuels and liquid water, and
positioning the in-tank filter housing in a fuel tank, the sodium polyacrylate mixture enclosed within the in-tank filter expanding into a space within the fuel tank and within the in-tank filter housing, the sodium polyacrylate mixture absorbing the liquid water.

7. The method of claim 6, the membrane comprising one or more of: fabric and mesh.

8. The method of claim 6, further comprising retrieving the in-tank filter housing by a cord connected to the in-tank filter housing.

9. The method of claim 6, the rigid housing being in the shape of a tube, box or other three-dimensional shape.

10. The method of claim 6, being used for petroleum diesels, biodiesels, gasolines, jet fuels and other liquid fuels and oils.
